(19) United States
(12) Patent Application Publication
(10) Pub. No.: US 2006/0256082 A1
(43) Pub. Date: Nov. 16, 2006

(54) Method of providing motion recognition information in portable terminal

(75) Inventors: Sung-Jung Cho, Suwon-si (KR); Eun-Kwang Ki, Seoul (KR); Dong-Yoon Kim, Seoul (KR); Jun-Il Sohn, Yongin-si (KR); Jong-Koo Oh, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/431,992

(22) Filed: May 11, 2006

(30) Foreign Application Priority Data
May 12, 2005 (KR) 2005-0039894

(51) Int. Cl. G09G 5/00

(52) U.S. Cl. 345/156

(57) ABSTRACT

The present invention relates generally to a method for providing motion information for motion recognition mode to user in a portable terminal. In the method, when using the motion recognition mode, the first notification is provided. It is determined if the sensed gesture of the user can be recognized. If the gesture cannot be recognized, the second notification is provided. If the user's gesture can be recognized, the motion recognition of the gesture is performed and compared with pre-registered gestures in the portable terminal. If the gesture is not a registered gesture, the third notification is provided. If the recognized gesture is registered, a function corresponding to the recognized gesture is selected and performed. The above method enables a user to effectively utilize a portable terminal equipped with motion recognition capabilities.

### PRIORITY

This application claims priority under 35 U.S.C. § 119 to an application entitled “Method of Providing Motion Recognition Information in Portable Terminal” filed in the Korean Intellectual Property Office on May 12, 2005 and assigned Serial No. 2005-39894, the contents of which are incorporated herein by reference.

### BACKGROUND OF THE INVENTION

1. Field of the Invention

The present invention relates to a method of providing information of motion recognition to a user in a portable terminal, and particularly to a method of providing information to a user of an input error in an easily recognizable fashion.

2. Description of the Related Art

Portable terminals such as a mobile communication terminal or a personal digital assistant (PDA) are becoming more widely used. In addition to handling telephone calls or scheduling management tasks, the portable terminals are providing various additional functions, for example, taking a picture by a built-in digital camera, watching a satellite broadcast, playing a game, etc.

Also, a user can control the portable terminal by moving or tipping it, and relying upon a built-in motion sensor, without using a keypad or a touch screen.

Thus, it is possible to make a telephone call or operate other functions of the portable terminal by specific gestures, without using the keypad.

For example, if the portable terminal having a built-in motion sensor is shaken up and down, spam messages are deleted. If a user gestures to describe a number with the portable terminal, the portable terminal recognizes the number as a dialing number and make a call to the corresponding telephone number. Also, if a user shakes the portable terminal it can produce sounds such as a tambourine or other percussion instruments. In particular, in case of using an online game or emoticon, when a user describes ‘0’ with the portable terminal, it can say “oh yes” or when a user describes ‘X’, it can say “oh no”. In addition, when the portable terminal is in a MP3 player mode a user by simply moving the portable terminal up and down can control various functions such as selecting other music.

As described above, if a portable terminal is motion recognition capable when a user operates the portable terminal by specific gestures, the functions corresponding to the gestures are performed. However; the motion recognition based on motion of input device is limited, since the capacity of sensing the user's writing motion is limited, the performance of recognition can deteriorate further due to sensing difficulties like, change the posture of the input device, slow motion sensors or when a sensed signal includes high noise levels created by shaking hands.

Accordingly, to successfully operate a motion recognition capable input device based on the user's writing motion it is necessary to inform the user about the correctness of a gesture input.

### SUMMARY OF THE INVENTION

Accordingly, an object of the present invention is to provide a method for providing a user with information for a correct gesture input in a motion recognition portable terminal.

Another object of the present invention is to provide a method informing a user about an input error due to an improper gesture input in an easily recognizable fashion in a motion recognition portable terminal.

According to the present invention for achieving the above objects, in the method for providing a user with information for motion recognition mode in a portable terminal, when using the motion recognition mode, the first notification is provided. It is determined if the sensed gesture of the user can be recognized. If the gesture cannot be recognized, the second notification is provided. If the user's gesture can be recognized, the motion recognition of the gesture is performed and compared with gestures pre-registered in the portable terminal. If the gesture is not a pre-registered gesture, the third notification is provided. If the recognized gesture is pre-registered, a function corresponding to the recognized gesture is selected and performed

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram of a portable terminal using motion recognition function according to the present invention;

FIG. 2A is a flowchart illustrating a procedure for carrying out the motion recognition according to the present invention;

FIG. 2B is a flowchart illustrating a procedure for providing the first notification information according to the present invention;

FIG. 2C is a flowchart illustrating a procedure for providing the second notification information according to the present invention;

FIG. 2D is a flowchart illustrating a procedure for providing the third notification information according to the present invention;

FIG. 3 shows screens illustrating notification information according to the present invention; and

FIG. 4 shows descriptive drawings illustrating gestures according to the present invention.

### DETAILED DESCRIPTION OF THE PREFERRED EMBODIMENTS

Preferred embodiments of the present invention will be described herein below with reference to the accompanying drawings. In the following description, a detailed description of well-known functions or constructions incorporated herein has been omitted for clarity and conciseness.

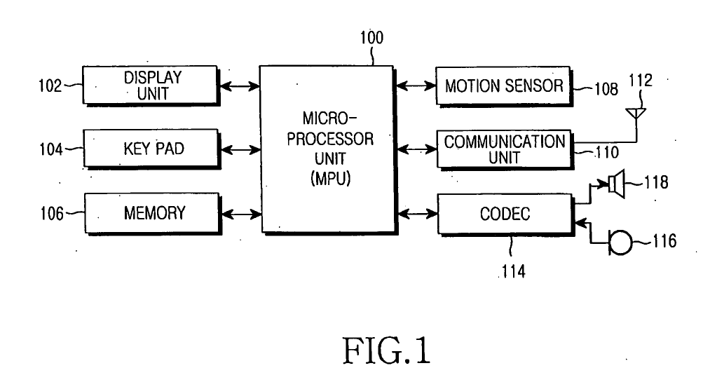

FIG. 1 illustrates a block diagram of a portable terminal capable of motion recognition according to the present invention. The portable terminal may include a Personal Data Assistant (PDA), a Personal Communication System (PCS), and a MP3 player (MPEG Audio Layer-3 Player), and the like.

Referring to FIG. 1, the portable terminal using a function of motion recognition includes a Micro-Processor Unit (MPU) 100, a display unit 102, a keypad 104, a memory 106, a motion sensor 108, a communication unit 110, an antenna 112, a CODEC 114, a microphone 116, and a speaker 118.

The MPU 100 controls the overall operation of the portable terminal with a motion recognition capability. For example, the MPU 100 is responsible for processing and controlling voice and data communication. In addition to the typical functions, the MPU 100 processes functions for analyzing the correct input of gestures used in the portable terminal and an input gesture received from the motion sensor 108, and provides the reason of an error to a display unit 102 if the input gesture has an error. Thus, a detailed description of the typical processing and controlling operation of the MPU 100 will be omitted.

A display unit 102 also displays status information (or indicator), numbers and characters, moving and still pictures, etc. In particular, the display unit 102 also displays information for the motion recognition provided from the MPU 100 according to the present invention.

A keypad 104 includes numeric keys and a plurality of function keys, such as a MENU key, a CANCEL (REMOVE) key, an ENTER key, a TALK key, an END key, an internet connection key, navigation keys (▴/▾/ [symbol] / [symbol] ). In addition to the typical functions, the keypad provides gesture keys for notifying start and end of motion recognition in the portable terminal. The key input data corresponding to a key pressed by the user is transmitted to the MPU 100.

A memory 106 stores a program for controlling overall operation of the portable terminal and temporarily stores data created during the operation of the terminal. Also, the memory 106 stores data, for example phone numbers, Short Message Service (SMS) messages, image data, etc. In addition to typical functions, the memory 106 stores a gesture database for functions having registered gestures.

A motion sensor 108 measures the motion of the portable terminal using an inertia sensor. The motion sensor 108, which is an accelerometer, measures acceleration along the X, Y and Z axes, and then measures a slope of the portable terminal and a gesture which is a moving motion based on the measured values.

A communication unit 110 transmits and receives a wireless signal of communication data through an antenna 112. For example, in case of the data reception, the communication unit 110 drops a frequency of an RF signal received through the antenna 112 and converts to a baseband signal, and performs de-spreading and channel decoding for receiving data. In case of the data transmission, the communication unit 110 performs channel coding and spreading transmitting data. Also, the communication unit 110 increases a frequency of a baseband signal, converts to an RF signal, and transmits it to the antenna 112.

A Coder-Decoder (CODEC) 114 connected to the MPU 100, a microphone 114, and a speaker 118 connected to the CODEC are audio input/output units for use in voice communication. The MPU 100 produces Pulse Code Modulation (PCM) data and the CODEC 114 converts the PCM data into analog audio signals. The analog audio signals are outputted through the speaker 118. Also, the CODEC 114 converts analog audio signals received through the microphone 116 into PCM data and provides the MPU 100 with the PCM data.

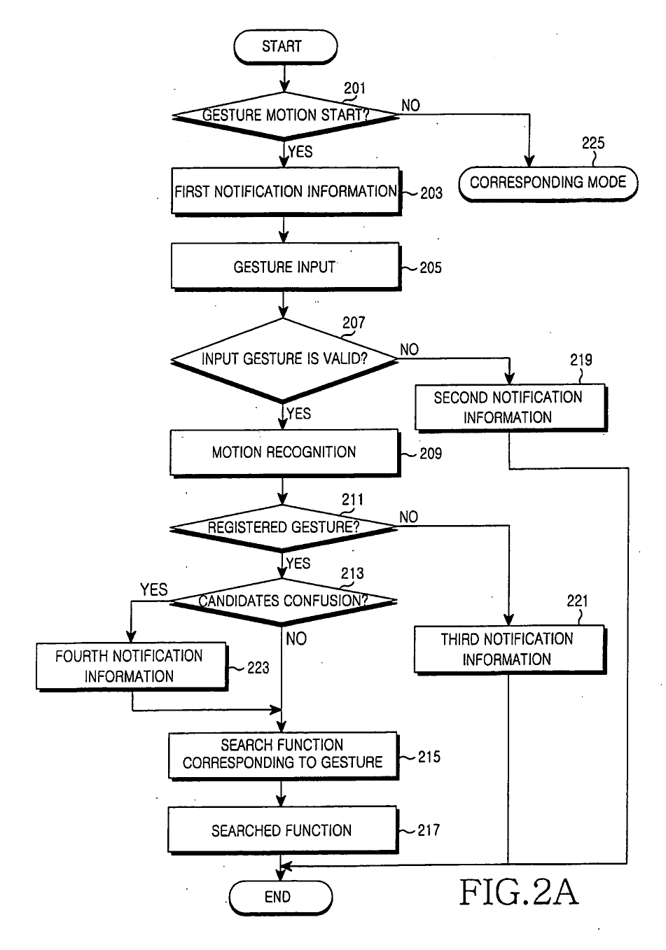

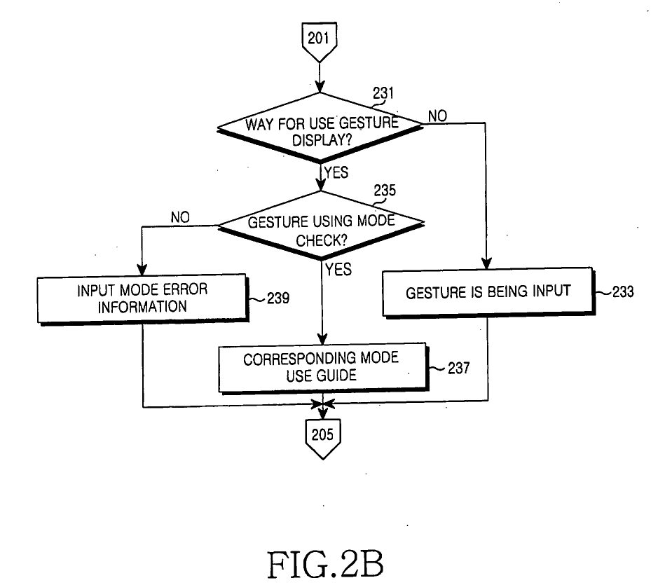

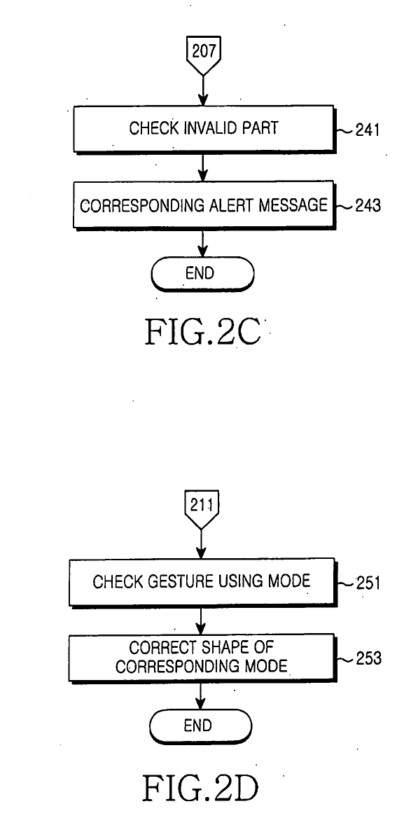

FIG. 2A illustrates a procedure for performing motion recognition according to the present invention.

Referring to FIG. 2A, in step 201, the MPU 100 determines if a gesture is started, that is, whether the motion recognition mode is used. For example, if a gesture key on the keypad 104 is pressed, the MPU 100 recognizes to start the motion recognition mode. Moreover, when the gesture key is pressed by the user, the MPU 100 determines the mode in which the input gesture is used, depending on the mode of the portable terminal (e.g., MP3 mode, SMS mode, and waiting mode). As another embodiment of the present invention, it may start gesture input when any key on the keypad 104 is pressed without having a separate gesture key.

If the motion recognition mode is not used, the MPU 100 proceeds to step 225 to perform a corresponding mode (e.g., a waiting mode).

If the motion recognition mode is used, in step 203, the MPU 100 provides a user with the first notification information, which will be described in detail in FIG. 2B.

The MPU 100 proceeds to step 205 to receive the user's gesture sensed by the motion sensor 108. When the gesture is sensed, the MPU 100 notifies the user that the gesture has been completely sensed (e.g., alert sound, completion screen display). Herein, if the motion is stopped for more than a predetermined time, if a predetermined time is passed after the motion recognition mode, or if the user takes his hands off the pressed gesture key, the MPU 100 recognizes that the gesture input motion has been completed. It will be described as an example that the gesture input ends when the user takes his hands off the gesture key.

If the user's gesture is provided, the MPU 100 proceeds to step 207 to confirm whether it is possible to recognize the motion of the gesture, that is the gesture is valid or not. Recognition of the motion of the gesture is to be determined by comparing it with a predetermined reference value. In the case when the motion sensor 108 works slowly or a sensed signal includes high noise levels due to shaking hands, recognition values may be under the reference value, thereby it is impossible to recognize the motion using the gesture.

If the value of the gesture does not meet the reference value, the MPU 100 proceeds to step 219 to provide the second notification information, which will be described in detail in FIG. 2C, which notifies that the gesture input produced an error and alerts the user about the nature of the error, and ends the algorithm.

If the MPU 100 determines that the input gesture can be used as an instruction, it proceeds to step 209. The MPU 100 measures accelerations along the X, Y and Z axes of the input gesture. Then, the MPU 100 calculates a pattern according to a change of the accelerations of each measured X, Y and Z axes, compares the calculated pattern with the predetermined gesture pattern, thereby recognizing the motion.

After this, the MPU 100 determines if the recognized gesture is registered in the portable terminal in step 211. In the method of determining whether the gesture is registered in the portable terminal, the matching point is calculated by comparing all of the registered gestures with the input gesture. It is determined if the input gesture is registered by comparing the calculated matching point with the predetermined value.

If there is no gesture which is the same as the input gesture among the registered gestures, in step 221 the MPU 100 provides the third notification information, which will be described in detail in FIG. 2D, which shows the correct gesture, and ends the algorithm.

If the gesture is the same as the registered gesture, the MPU 100 determines if the input gesture is confused between the registered gestures in step 213. That is, the MPU 100 verifies whether the input gesture is confused among the registered gestures. If a difference of the matching point between the input gesture and any of the registered gestures is less than a certain predetermined value, it is difficult to select the proper registered gestures.

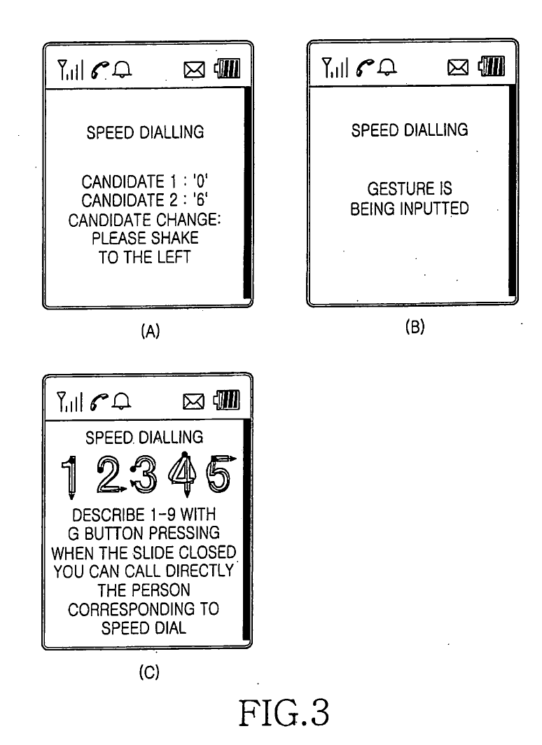

If the gestures are confused, the MPU 100 proceeds to step 223 to provide the fourth notification information for selecting one of the confused gestures. For example, as shown in diagram (A) of FIG. 3, when the input gesture is confused between 0 and 6, it takes a certain gesture (e.g., “Candidate change: Please shake to the left”) and selects the input gesture. And then, the MPU 100 proceeds to step 215.

If the input gesture is not confused, the MPU 100 proceeds to the step 215 to search the corresponding motion to the input gesture. In step 217, the MPU 100 performs the searched motion and ends this algorithm.

FIG. 2B illustrates a procedure for providing the first notification information according to the present invention.

Referring to the FIG. 2B, when the motion recognition mode is used in step 201 of FIG. 2B, the MPU 100 determines if a menu displaying the way for use the motion recognition mode by a key manipulation has been set in step 231. If it has been not set the menu for displaying the way for use the motion recognition mode, the MPU 100 proceeds to step 233 to provide information indicating that the gesture is being input, as illustrated in diagram (B) of FIG. 3. Then, the MPU 100 proceeds to step 205 of FIG. 2A.

If the menu for displaying the way for use the motion recognition mode has been set, the MPU 100 proceeds to step 235 to determine the mode (e.g., speed dial mode, sound describe mode, MP3 control mode, message delete mode) for use the gesture. If it can not determine the mode for use the gesture, in step 239, the MPU 100 provides the gesture input mode verification error information and proceeds to step 205 of FIG. 2A.

When the mode for use the gesture is determined, the MPU 100 proceeds to 237 to display a use guide corresponding to the mode to the display unit. For example, in case of the speed dialing mode, it is displayed how to input a number between 0 to 9 as illustrated in diagram (C) of FIG. 3, and in case of the sound description mode, it is displayed how to input an O/X. Also, in case of the MP3 control mode, it is displayed how to control MP3 player, and in case of the message deletion mode, it is displayed how to delete the message. After this, the MPU 100 proceeds to step 205 of FIG. 2A.

FIG. 2C is a flowchart illustrating a procedure for providing the second notification information according to the present invention.

Referring to FIG. 2C, if the gesture input in step 207 of FIG. 2A is not valid, the MPU 100 determines an invalid part in step 241. For example, the MPU 100 determines if the gesture input motion is too fast or slow, if the gesture key is not pressed while inputting, or if the user's posture is incorrect.

After determining the invalid part, the MPU 100 provides an alert message for the invalid part in step 243. For example, if the gesture input motion is too fast, a message for alerting that the input motion is so fast that the motion cannot be recognized is provided. If user's posture is incorrect, a message for correcting the user's posture is provided. After this, the MPU 100 ends this algorithm.

FIG. 2D is a flowchart illustrating a procedure for providing the third notification information according to the present invention.

Referring to FIG. 2D, if the input gesture is not registered in the portable terminal in step 211 of FIG. 2A, the MPU 100 determines the mode (e.g., speed dialing mode, sound description mode, MP3 control mode, and message deletion mode) for use the input gesture in step 251.

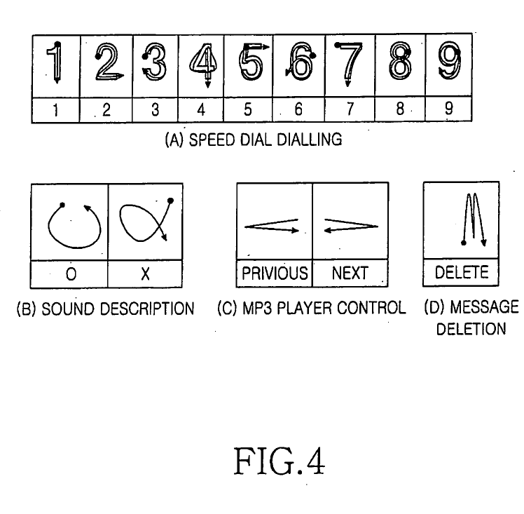

After determining the mode for use the gesture, the MPU 100 proceeds to step 253 to display the correct way of gesture input corresponding to the mode to the display unit 102. For example, in the case of the speed dialing mode, it is displayed how to input a number between 0 to 9 as illustrated in diagram of (A) FIG. 4, and in the case of the sound description mode, it is displayed how to input an O/X as illustrated in diagram (B) of FIG. 4. Also, in case of the MP3 control mode, it is displayed how to control MP3 player as illustrated in diagram (C) of FIG. 4, and in case of the message deletion mode, it is displayed how to delete the message as illustrated in diagram (D) of FIG. 4.

After this, the MPU 100 ends this algorithm.

As described above, if the motion recognition is used in a portable terminal, the present invention provides for the correct way of input and indicating the errors when inputting the wrong gesture. Accordingly, the user performing the motion recognition can more easily and conveniently use the motion recognition function.

While the present invention has been shown and described with reference to preferred embodiments thereof, it will be understood by those skilled in the art that various changes in form and details may be made therein without departing from the spirit and scope of the present invention as defined by the appended claims.

What is claimed is:

1. A method for providing motion information in a mobile communication terminal, comprising the steps of:
providing a first notification when using a motion recognition mode;
determining if a sensed gesture can be recognized, and providing a second notification if the gesture cannot be recognized; and
comparing gestures registered in the portable terminal with a recognized gesture if the sensed gesture can be recognized, and providing a third notification if the sensed gesture is not a registered gesture.

2. The method of claim 1, further comprising the steps of:
searching for a function corresponding to the recognized gesture if the recognized gesture is registered; and
performing the searched function.

3. The method of claim 1, wherein the sensed gesture is to perform at least one of an MP3 (MPEG Audio Layer-3) player control, speed dialing, sound description, and message deletion.

4. The method of claim 1, wherein the start of the motion recognition mode is performed by pressing a gesture button.

5. The method of claim 1, wherein the first notification includes a user guide to assist the user with the correct input of gesture.

6. The method of claim 1, wherein the first notification includes a user guide of motion recognition depending on each motion recognition mode in order to help the user correctly input a gesture.

7. The method of claim 1, wherein whether the motion recognition is possible is determined by whether the motion is to slow or to fast that it cannot be recognized, or whether the recognized gesture includes a high noise level due to shaking hands.

8. The method of claim 1, wherein the second notification includes error information for determining whether a motion of the gesture can be recognized so that the user can be aware that the input is incorrect.

9. The method of claim 1, wherein the third notification includes the correct way to input a gesture if the recognized gesture is not registered in the portable terminal.

10. The method of claim 1, wherein the first notification, the second notification and the third notification are provided by at least one of a sound, a screen display, and a vibration.

11. The method of claim 2, further comprising the steps of:
determining that at least two similar gestures among the registered gestures exist and that it is difficult to select a correct registered gesture, if the recognized gesture is registered; and
providing a fourth notification if it is difficult to select the correct registered gesture.

12. The method of claim 11, wherein the fourth notification includes information which instructs the user to select a registered gesture.

13. The method of claim 11, wherein the fourth notification is provided by at least one of a sound, a screen display, and a vibration.

14. A method for providing motion information in a mobile communication terminal using a motion recognition mode, comprising the steps of:
providing a first notification when the motion recognition mode is initiated;
determining if a sensed gesture can be recognized, and providing a second notification if the gesture cannot be recognized; and
comparing gestures registered in the portable terminal with the sensed gesture, and providing a third notification if the gesture is not a registered gesture.

15. The method of claim 14, further comprising the steps of:
searching for a function corresponding to the recognized gesture if the recognized gesture is registered; and
performing the searched function.

16. The method of claim 13, wherein the second notification includes a cause of an input error for determining whether a motion of the gesture can be recognized to inform the user that the way of input is incorrect.

17. The method of claim 13, further comprising the steps of:
determining that at least two similar gestures among the registered gestures exist and that it is difficult to select a correct registered gesture, if the recognized gesture is registered; and
providing a fourth notification if it is difficult to select the correct registered gesture.

18. The method of claim 17, wherein the fourth notification includes information instructing the user to select a registered gesture.

19. The method of claim 17, wherein the fourth notification is provided by at least one of a sound, a screen display, and a vibration.
